(19) United States
(12) Patent Application Publication
(10) Pub. No.: US 2024/0125688 A1
(43) Pub. Date: Apr. 18, 2024

(54) PORE DEVICE AND FINE PARTICLE MEASUREMENT SYSTEM

(71) Applicant: ADVANTEST CORPORATION, Tokyo (JP)

(72) Inventors: Yasuharu IMAI, Tokyo (JP); Nobuei WASHIZU, Tokyo (JP); Kosuke OINUMA, Tokyo (JP)

(21) Appl. No.: 18/485,415

(22) Filed: Oct. 12, 2023

(30) Foreign Application Priority Data
Oct. 14, 2022 (JP) 2022-165568

(51) Int. Cl. G01N 15/12

(52) U.S. Cl. CPC G01N 15/1209; G01N 2015/1254

(57) ABSTRACT

A pore device is used with a measurement device. The pore device includes a pore chip and a chip case which has a chamber partitioned by the pore chip. A measurement terminal group is provided to apply an electric signal from the measurement device to the chamber and output an electric signal generated in the chamber to the measurement device. Interface means is connected to a nonvolatile memory such that the nonvolatile memory is accessible from an outside of the pore device.

### CROSS REFERENCE TO RELATED APPLICATIONS

The present invention claims priority under 35 U.S.C. § 119 to Japanese Application, 2022-165568, filed on Oct. 14, 2022, the entire contents of which being incorporated herein by reference.

### BACKGROUND

### 1. Technical Field

The present disclosure relates to a pore device.

### 2. Description of the Related Art

A particle size distribution measurement method called an electrical sensing zone method (Coulter's principle) has been known. In this measurement method, an electrolytic solution containing particles is passed through a pore called a nanopore. When the particles pass through the pore, the electrolytic solution in the pore decreases by an amount corresponding to a volume of the particles, and an electrical resistance of the pore is increased. Therefore, a particle size can be measured by measuring the electrical resistance of the pore.

FIG. 1 is a block diagram of a fine particle measurement system 1R based on an electrical sensing zone method. The fine particle measurement system 1R includes a pore device 100R, a measurement device 200R, and a data processing device 300.

An inside of the pore device 100R is filled with an electrolytic solution 2 containing particles 4 to be detected. The inside of the pore device 100R has two chambers which is separated by a pore chip 102, and an electrode 106 and an electrode 108 are provided in the two chambers. When a potential difference is generated between the electrode 106 and the electrode 108, an ion current flows between the electrodes, and the particles 4 move from one chamber to the other chamber via a pore 104 by electrophoresis.

The measurement device 200R generates the potential difference between a pair of electrodes 106 and 108 and acquires information correlated with a resistance value Rp between the pair of electrodes. The measurement device 200R includes a transimpedance amplifier 210, a voltage source 220, and a digitizer 230. The voltage source 220 generates a potential difference Vb between the pair of electrodes 106 and 108. The potential difference Vb serves as a drive source of electrophoresis and also serves as a bias signal for measuring the resistance value Rp.

A small current Is inversely proportional to a resistance of the pore 104 flows between the pair of electrodes 106 and 108.

Is=Vb/Rp (1)

The transimpedance amplifier 210 converts the small current Is into a voltage signal Vs. When a conversion gain is r, the following equation is established.

Vs=−r×Is (2)

When Equation (1) is substituted into Equation (2), Equation (3) is obtained.

Vs=−Vb×r/Rp (3)

The digitizer 230 converts the voltage signal Vs into digital data Ds. As described above, the measurement device 200R can obtain the voltage signal Vs inversely proportional to the resistance value Rp of the pore 104.

FIG. 2 is a waveform chart of an illustrative small current Is measured by the measurement device 200R. Note that, a vertical axis and a horizontal axis of the waveform chart and a time chart referred to in the present specification are appropriately enlarged and reduced for easy understanding, and waveforms to be illustrated are also simplified or exaggerated or emphasized for easy understanding.

The resistance value Rp of the pore 104 increases for a short period during which the particles pass. Therefore, the current Is decreases in a pulse shape whenever the particles pass. Amplitudes of individual pulse currents correlate with particle sizes. The data processing device 300 processes the digital data Ds and analyzes the number, particle size distribution, and the like of the particles 4 contained in the electrolytic solution 2. A part of the data processing device 300 may be a server or a cloud.

The fine particle measurement is roughly divided into a measurement step and an analysis step. The measurement step is a step of measuring the small current Is by using the measurement device. The analysis step is a step of deriving the number, the particle size distribution, and the like of particles based on waveform data of the small current Is.

In the analysis step, manufacturing information (pore diameter, design version, a manufacturing date, and a lot) of the pore device is extremely important information for correctly analyzing a signal obtained by the measurement device. In particular, since the pore device is improved and updated every day, when these pieces of information are not correctly acquired, the analysis result is influenced.

Since the particle size distribution measurement method using the pore device has been in practical use for a short time, it can be said that the pore device is not a completed technology and product and has room for improvement. Therefore, the pore device is improved and updated every day. Therefore, data obtained in the measurement step may be different from the data in the related art, and it is important to know a factor for developing a better pore device.

In addition, since the pore device is a consumable on the premise of being disposable and has an expiration date that can be used for measurement, information on a date and time when the pore device is manufactured is also required.

Further, usage information (particles to be used, the number of passing particles, solutions to be used, serials of measuring instruments, and the like) of the pore device is important feedback information for quality control and future development of the pore device.

In a case where a human manages these pieces of important information, a human error cannot be avoided, and correct information may be lost. In addition, in a case where a manufacturer of the pore device, a user engaged in the measurement step, and an analyst engaged in the analysis step are separate parties, a technology for integrally managing information of the pore device is required.

### SUMMARY

The present disclosure has been made in such a situation, and one illustrative object of a certain aspect thereof is to provide a pore device of enabling accurate information management.

A certain aspect of the present disclosure relates to a pore device used with a measurement device. The pore device includes a pore chip, two chambers partitioned by the pore chip, a measurement terminal group structured to apply an electric signal from the measurement device to the two chambers and output an electric signal generated in the two chambers to the measurement device, a nonvolatile memory, and interface means connected to the nonvolatile memory such that the nonvolatile memory is accessible from an outside of the pore device.

Another aspect of the present disclosure is a fine particle measurement system. The fine particle measurement system includes a pore device and a measurement device. The pore device includes a pore chip, two chambers partitioned by the pore chip, a measurement terminal group structured to apply an electric signal from the measurement device to the two chambers and output an electric signal generated in the two chambers to the measurement device, a nonvolatile memory, and interface means connected to the nonvolatile memory such that the nonvolatile memory is accessible from an outside of the pore device.

Note that, any combinations of the above components and mutual replacements of components and expressions among methods, apparatuses, systems, and the like are also effective as embodiments of the present disclosure or the present invention. Further, the description of this item (means for solving the problem) does not describe all essential features of the present invention, and thus subcombinations of these described features may also be the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram of a fine particle measurement system using an electrical sensing zone method;

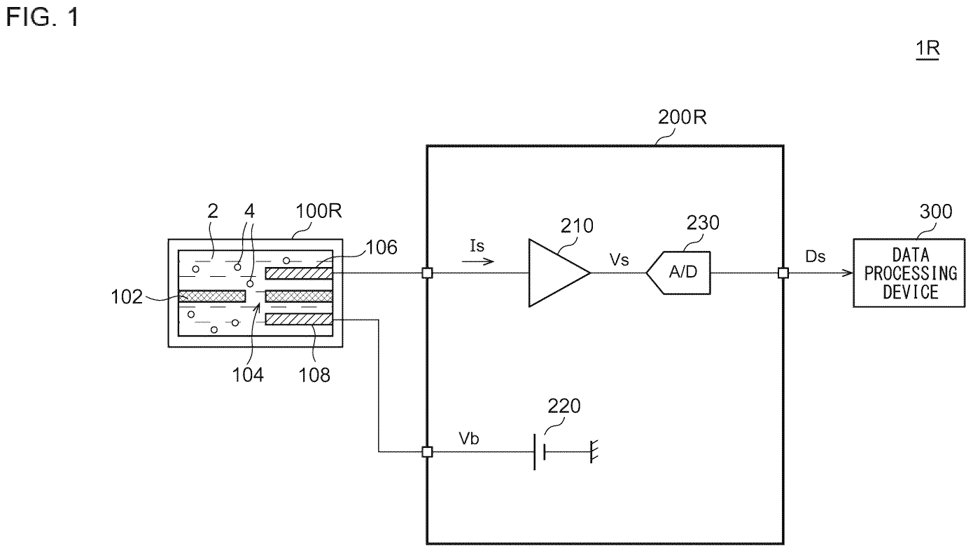

FIG. 2 is a waveform chart of an illustrative small current Is measured by a measurement device;

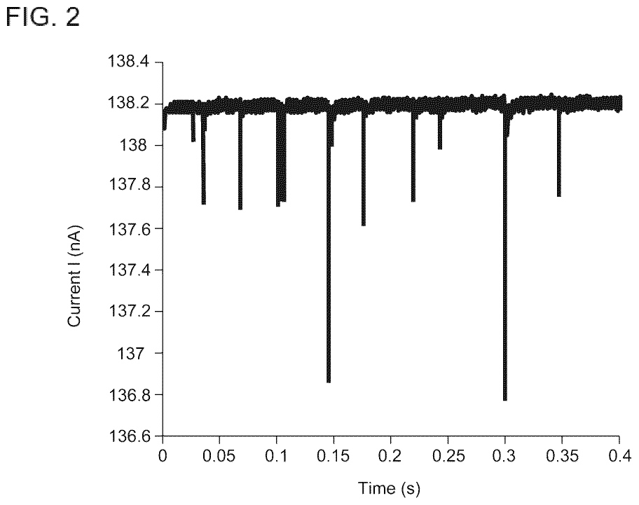

FIG. 3 is a block diagram of a fine particle measurement system including a pore device according to a first embodiment;

FIG. 4 is a block diagram illustrating a configuration example of a memory interface and interface means;

FIG. 5A and FIG. 5B are diagrams illustrating a structure of the pore device; and

FIG. 6 is a block diagram of a fine particle measurement system according to a modification.

### DETAILED DESCRIPTION

### Outline of Embodiments

An outline of some illustrative embodiments of the present disclosure will be described. This outline describes some concepts of one or a plurality of embodiments in a simplified manner for the purpose of basic understanding of the embodiment as an introduction of detailed description to be described below and does not limit the breadth of the invention or disclosure. This outline is not a comprehensive outline of all embodiments to be considered and is not intended to specify key elements of all the embodiments or delineate the scope of some or all of the embodiments. For the sake of convenience, “one embodiment” may be used to refer to one embodiment (example or modification) or a plurality of embodiments (examples or modifications) disclosed in the present specification.

A pore device according to one embodiment is used together with a measurement device. The pore device includes a pore chip, two chambers partitioned by the pore chip, a measurement terminal group structured to apply an electric signal from the measurement device to the two chambers and/or to output an electric signal generated in the two chambers to the measurement device, a nonvolatile memory, and interface means connected to the nonvolatile memory such that the nonvolatile memory is accessible from an outside of the pore device.

When a human manages the pore device and information on the pore device in association with each other in a database on a computer, input errors and input omissions cannot be avoided. By contrast, the nonvolatile memory is incorporated in the pore device, and thus, information necessary for a manufacturer, a user, or an analyst can be accurately recorded in the pore device. As a result, more accurate information management can be performed as compared with a case where the human manages information on the computer.

In one embodiment, the nonvolatile memory may store unique information of the pore device in advance of shipment of the pore device. The unique information may include a serial number, a pore diameter, a manufacturing date, an expiration date, version information, a lot number, and the like.

In one embodiment, a usage history of the pore device may be writable to the nonvolatile memory when the pore device is used. The use history may include at least one of (i) measurement conditions and (ii) measurement results. Examples of the measurement conditions include an applied voltage, particles to be used, a serial number and version information of the measurement device, and the like. Examples of the measurement results include the number of passing particles, a used solution, a measured current amount, a change amount of a current, a maximum value of a current, noise, measurement start point in time and end point in time, and the like. When the manufacturer of the pore device may retrieve a certain pore device, information is read from the nonvolatile memory of the pore device, and thus, the pore device can be used for failure analysis of the pore device or can be fed back into future design and refinement.

In one embodiment, the interface means may include a plurality of terminals to be coupled to a memory interface of the measurement device with the nonvolatile memory.

In one embodiment, the interface means, and the nonvolatile memory constitute a radio frequency (RF) tag, and the RF tag may be accessible from a reader and writer of the measurement device in a non-contact manner.

In one embodiment, the pore device may further include a contact sheet on which the nonvolatile memory and the interface means are mounted, and a pore chip case housing the pore chip and bonded with the contact sheet.

A fine particle measurement system according to one embodiment includes a pore device and a measurement device. The pore device includes a pore chip, two chambers partitioned by the pore chip, a measurement terminal group structured to apply an electric signal from the measurement device to the two chambers and/or to output an electric signal generated in the two chambers to the measurement device, a nonvolatile memory, and interface means connected to the nonvolatile memory such that the nonvolatile memory is accessible from an outside of the pore device.

In one embodiment, unique information of the pore device may be stored in the nonvolatile memory in advance of shipment of the pore device, and the measurement device may read the unique information from the nonvolatile memory and automatically set measurement conditions in accordance with the unique information.

In one embodiment, the measurement device may be capable of writing a use history of the pore device to the nonvolatile memory when the pore device is used.

In one embodiment, the interface means may include a plurality of terminals to be coupled to a memory interface of the measurement device with the nonvolatile memory.

In one embodiment, the interface means, and the nonvolatile memory constitute a radio frequency (RF) tag, and the RF tag may be accessible from a reader and writer of the measurement device in a non-contact manner.

In one embodiment, the pore device may further include a contact sheet on which the nonvolatile memory and the interface means are mounted, and a pore chip case housing the pore chip and bonded with the contact sheet.

### EMBODIMENTS

Hereinafter, preferred embodiments will be described with reference to the drawings. The same or equivalent components, members, and processing illustrated in the drawings are denoted by the same reference signs, and the redundant description will be omitted as appropriate. In addition, the embodiments are not intended to limit the disclosure and invention but are examples, and all features described in the embodiments and combinations thereof are not necessarily essential to the disclosure and invention.

In addition, dimensions (thickness, length, width, and the like) of each member described in the drawings may be appropriately enlarged and reduced for easy understanding. Further, dimensions of the plurality of members do not necessarily indicate a magnitude relationship therebetween, and even though a certain member A is drawn thicker than another member B in the drawing, the member A may be thinner than the member B.

In the present specification, a “state where the member A is connected to the member B” includes not only a case where the member A and the member B are physically and directly connected to each other, but also a case where the member A and the member B are indirectly connected to each other with another member, which does not substantially influence an electrical connection state between these members or which does not impair a function or an effect exhibited by coupling these members, interposed therebetween.

Similarly, a “state where a member C is connected (provided) between the member A and the member B” includes not only a case where the member A and the member C or the member B and the member C are directly connected to each other, but also a case where these members are indirectly connected to each other with another member, which does not substantially influence an electrical connection state between these members or which does not impair a function or an effect exhibited by coupling these members, interposed therebetween.

In addition, in the present specification, an electric signal such as a voltage signal or a current signal, or a sign attached to a circuit element such as a resistor, a capacitor, or an inductor represents a voltage value, a current value, or a circuit constant (resistance value, capacitance value, and inductance) as necessary.

### First Embodiment

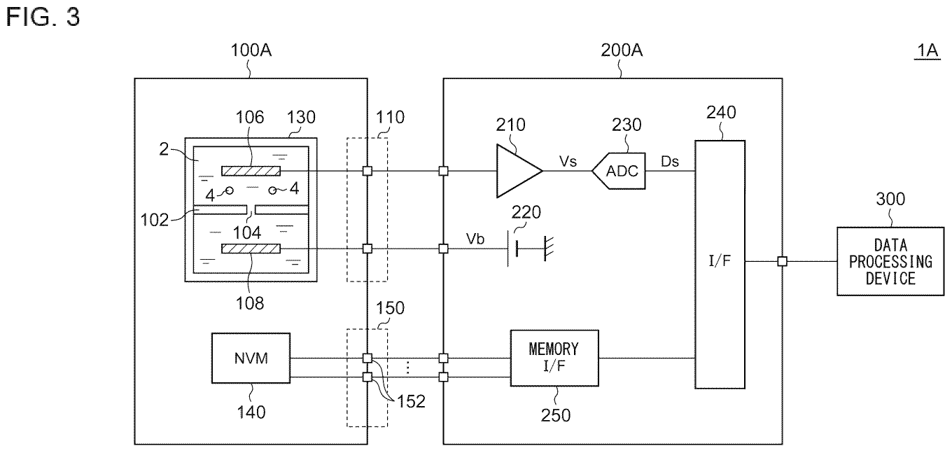

FIG. 3 is a block diagram of a fine particle measurement system 1A including a pore device 100A according to a first embodiment. The fine particle measurement system 1A includes the pore device 100A, a measurement device 200A, and a data processing device 300.

The pore device 100A is used together with the measurement device 200A. The pore device 100A is also referred to as a pore module. The pore device 100A includes a pore chip 102, a chip case 130, a nonvolatile memory 140, a measurement terminal group 110, and interface means 150.

The pore chip 102 is housed in the chip case 130. A chamber which is an internal space of the chip case 130 is filled with an electrolytic solution 2 containing particles 4 to be detected. The chamber, which is the internal space of the chip case 130, is separated into two chambers by the pore chip 102, and an electrode 106 and an electrode 108 are provided in two chambers.

The measurement terminal group 110 includes pads or pins, respectively, connected to the electrodes 106 and 108. The measurement terminal group 110 is provided to apply electric signals from the measurement device 200A to the electrodes 106 and 108 in the chamber and output electric signals generated in the electrodes 106 and 108 in the chamber to the measurement device 200A.

The nonvolatile memory 140 is an electrically erasable programmable read-only memory (EEPROM), a magnetoresistive random access memory (MRAM), a flash memory, or the like.

The interface means 150 is connected to the nonvolatile memory 140 and is provided to access the nonvolatile memory 140 from the measurement device 200A. In the present embodiment, the interface means 150 includes a memory access terminal group 152 to be coupled to a memory interface 250 of the measurement device 200 to the nonvolatile memory 140. Terminals of the memory access terminal group 152 are pads or pins. The number of terminals included in the memory access terminal group 152 varies depending on the type and interface of the nonvolatile memory 140.

The above configuration is a configuration of the pore device 100A. Next, a configuration of the measurement device 200A will be described.

The measurement device 200A applies a potential difference between the electrode 106 and the electrode 108 of the pore device 100A. As a result, an ion current or electrophoresis is generated in the electrolytic solution 2. By this ion current or electrophoresis, the particles 4 move from one chamber to the other chamber via a pore 104. An impedance between the electrode 106 and the electrode 108 changes in accordance with the diameter and type of the particles 4 passing through the pore 104. The measurement device 200A generates a potential difference between a pair of electrodes 106 and 108 and measures information correlated with an impedance Rp between the pair of electrodes 106 and 108.

The measurement device 200A includes a transimpedance amplifier 210, a voltage source 220, a digitizer 230, an interface circuit 240, and a memory interface 250. The voltage source 220 generates a potential difference (bias voltage) Vb between the pair of electrodes 106 and 108. The potential difference Vb serves as a drive source of electrophoresis and also serves as a bias signal for measuring the resistance value Rp.

A small current Is inversely proportional to a resistance of the pore 104 flows between the pair of electrodes 106 and 108.

Is=Vb/Rp (1)

The transimpedance amplifier 210 converts the small current Is into a voltage signal Vs. When a conversion gain is r, the following equation is established.

Vs=−r×Is (2)

When Equation (1) is substituted into Equation (2), Equation (3) is obtained.

Vs=−Vb×r/Rp (3)

The digitizer 230 converts the voltage signal Vs into digital data Ds. The interface circuit 240 is connected to the data processing device 300. The data processing device 300 is hardware that controls the measurement device 200A and is a general-purpose computer or dedicated hardware. The data processing device 300 executes a measurement program and transmits an operation parameter and the like to the interface circuit 240 of the measurement device 200A. The interface circuit 240 transmits the measured digital data Ds to the data processing device 300.

In the stand-alone fine particle measurement system 1A, the data processing device 300 may analyze the digital data Ds. In a case where the data processing device 300 is connected to a server via a network, the digital data Ds may be analyzed in the server.

The memory interface 250 is connected to the nonvolatile memory 140 via the interface means 150. The configuration and type of the memory interface 250 vary depending on the type and configuration of the nonvolatile memory 140.

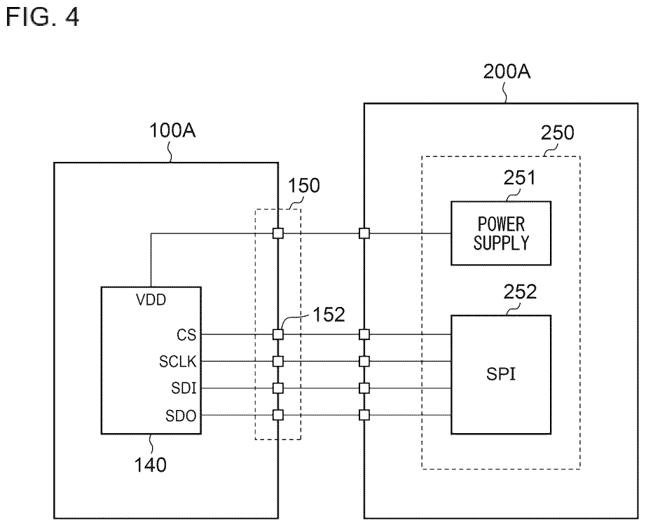

FIG. 4 is a block diagram illustrating a configuration example of the memory interface 250 and the interface means 150. In this example, the nonvolatile memory 140 is a serial EEPROM having a serial peripheral interface (SPI). In this case, the memory interface 250 includes a power supply circuit 251 and an interface circuit 252 of the SPI. The interface circuit 252 can directly access the nonvolatile memory 140, and accordingly, the interface means 150 includes only the memory access terminal group 152. I²C may be used instead of the SPI.

The above configuration is a configuration of the measurement device 200A.

When a human manages the pore device and information on the pore device in association with each other in a database on a computer, input errors and input omissions cannot be avoided. By contrast, the nonvolatile memory is incorporated in the pore device, and thus, information necessary for a manufacturer, a user, or an analyst can be accurately recorded in the pore device. As a result, more accurate information management can be performed as compared with a case where the human manages information on the computer.

Hereinafter, information that can be stored in the nonvolatile memory 140 will be described.

In the nonvolatile memory 140, unique information of the pore device 100A is stored in advance of shipment of the pore device 100A. Examples of the unique information include a serial number, a pore diameter, a manufacturing date, version information, a lot number, and a recommended operation parameter (for example, a voltage value of a bias voltage).

For example, when the pore device 100A is attached, the measurement device 200A accesses the nonvolatile memory 140 and reads the unique information. The measurement device 200A transmits the read unique information to the data processing device 300.

For example, in a case where the unique information includes the pore diameter, the data processing device 300 stores a value of the pore diameter together with the digital data Ds or transmits the value to the server. As a result, the pore diameter necessary for analysis can be accurately managed in combination with the digital data Ds.

In addition, the data processing device 300 may automatically calculate the operation parameter of the measurement device 200A in accordance with the read pore diameter and may set the automatically calculated operation parameter in the measurement device 200A. As a result, the user can omit manual input of data that has been conventionally performed in a GUI.

In a case where the unique information includes a parameter that defines a recommended operation condition of the measurement device 200A, the data processing device 300 may set an operation state of the measurement device 200A based on the parameter.

In a case where the unique information includes the manufacturing date and the expiration date of the pore device 100A, in a case where the expiration date has passed or the expiration date is approaching, the data processing device 300 may give a warning indicating that the expiration date has passed or is approaching.

The data processing device 300 may control the measurement device 200A to write a use history of the pore device 100A to the nonvolatile memory 140 of the pore device 100A. The use history is useful when the manufacturer of the pore device 100A retrieves and analyzes the used pore device 100A and can be used for improving the pore device 100A by collating the use history with a failure or deterioration of the pore device 100A.

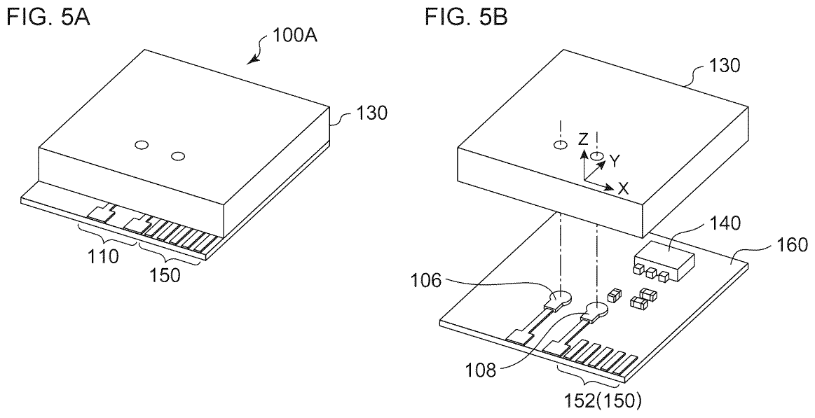

FIG. 5A and FIG. 5B are diagrams illustrating a structure of the pore device 100A. FIG. 5A is a perspective view of the pore device 100A, and FIG. 5B is an exploded perspective view of the pore device 100A. The pore device 100A includes the chip case 130, the nonvolatile memory 140, and a contact sheet 160. The contact sheet 160 is a printed circuit board, and the nonvolatile memory 140 is mounted on the contact sheet 160. In addition, the measurement terminal group 110 and the memory access terminal group 152 are formed in the contact sheet 160. The chip case 130 is bonded to the contact sheet 160. The contact sheet 160 may be an application specific integrated circuit (ASIC).

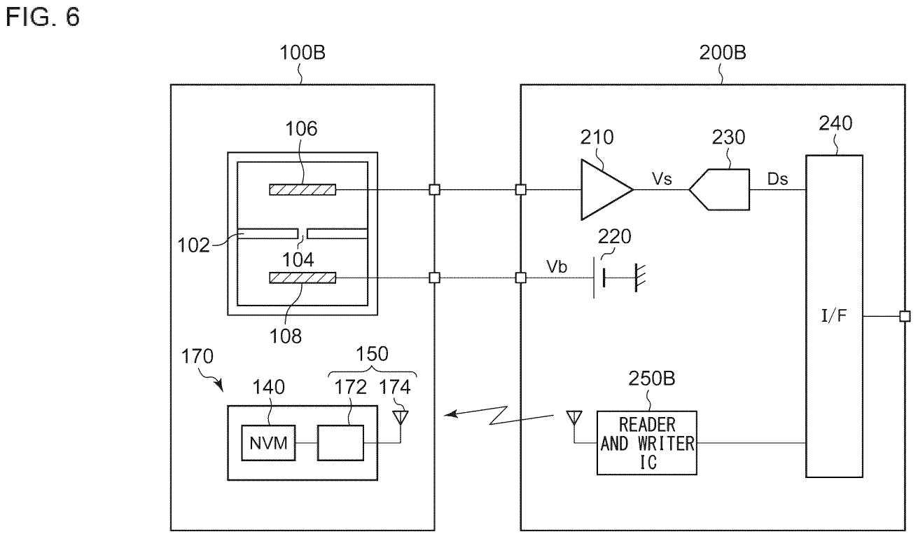

FIG. 6 is a block diagram of a fine particle measurement system 1B according to a modification. A pore device 100B includes a chip case 130 and a radio frequency (RF) tag 170. The RF tag 170 includes a nonvolatile memory 140, an RF unit 172, and an antenna 174, and is modularized. The RF unit 172 and the antenna 174 correspond to the interface means 150. The nonvolatile memory 140 is a FeRAM or an EEPROM.

The measurement device 200B includes a reader and writer IC 250B as the memory interface 250. The reader and writer IC 250B performs wireless communication with the RF tag 170, writes data to the nonvolatile memory 140, and reads data from the nonvolatile memory 140.

Although the fine particle measurement device has been described in the present specification, the application of the present invention is not limited thereto. The fine particle measurement device can be widely used for measuring instruments with small current measurement using a pore device such as a DNA sequencer.

Although the present invention has been described based on the embodiments, the embodiments merely illustrate the principle and application of the present invention. Many modifications and changes in arrangement are recognized in the embodiments without departing from the spirit of the present invention defined in the claims.

What is claimed is:

1. A pore device used together with a measurement device, the pore device comprising:
a pore chip;
a chamber partitioned by the pore chip;
a measurement terminal group structured to apply an electric signal to the chamber from the measurement device and/or to output an electric signal generated in the chamber to the measurement device;
a nonvolatile memory; and
interface means connected to the nonvolatile memory such that the nonvolatile memory is accessible from an outside of the pore device.

2. The pore device according to claim 1, wherein the nonvolatile memory is structured to store unique information of the pore device in advance of shipment of the pore device.

3. The pore device according to claim 1, wherein a use history of the pore device is writable to the nonvolatile memory during the time of using the pore device.

4. The pore device according to claim 1, wherein the interface means includes a plurality of terminals to be coupled to a memory interface of the measurement device to the nonvolatile memory.

5. The pore device according to claim 1,
wherein the interface means, and the nonvolatile memory constitute a radio frequency (RF) tag, and
the RF tag is accessible from a reader and writer of the measurement device in a non-contact manner.

6. The pore device according to claim 1, further comprising:
a contact sheet on which the nonvolatile memory and the interface means are mounted; and
a pore chip case structured to house the pore chip and is bonded to the contact sheet.

7. A fine particle measurement system comprising:
a pore device; and
a measurement device,
wherein the pore device includes
a pore chip,
a chamber partitioned by the pore chip,
a measurement terminal group structured to apply an electric signal to the chamber from the measurement device and output an electric signal generated in the chamber to the measurement device,
a nonvolatile memory, and
interface means connected to the nonvolatile memory such that the nonvolatile memory is accessible from an outside of the pore device.

8. The fine particle measurement system according to claim 7,
wherein the nonvolatile memory is structured to store unique information of the pore device in advance of shipment of the pore device, and
the measurement device is structured to read the unique information from the nonvolatile memory and automatically set measurement conditions in accordance with the unique information.

9. The fine particle measurement system according to claim 7, wherein the measurement device is structured to write a use history of the pore device to the nonvolatile memory during the time of using the pore device.

10. The fine particle measurement system according to claim 7, wherein the interface means includes a plurality of terminals to be coupled to a memory interface of the measurement device to the nonvolatile memory.

11. The fine particle measurement system according to claim 7,
wherein the interface means, and the nonvolatile memory constitute a radio frequency (RF) tag, and
the RF tag is accessible from a reader and writer of the measurement device in a non-contact manner.

12. The fine particle measurement system according to claim 7, further comprising:
a contact sheet on which the nonvolatile memory and the interface means are mounted; and
a pore chip case structured to house the pore chip and is bonded to the contact sheet.
